(19) United States
(12) Patent Application Publication
(10) Pub. No.: US 2006/0069002 A1
(43) Pub. Date: Mar. 30, 2006

(54) Process for preparing automatic dishwashing detergent compositions comprising potassium tripolyphosphate formed by in-situ hydrolysis

(75) Inventors: Brian Xiaoqing Song, Mason, OH (US); Frank William DeNome, Cincinnati, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company, Cincinnati, OH (US)

(21) Appl. No.: 11/227,361

(22) Filed: Sep. 15, 2005

Related U.S. Application Data
(60) Provisional application No. 60/613,696, filed on Sep. 28, 2004.

(51) Int. Cl. C11D 3/39

(52) U.S. Cl. 510/220

(57) ABSTRACT

A process for preparing substantially sodium ion-free, aqueous ADW detergent compositions comprising potassium tripolyphosphate, formed by in-situ hydrolysis, is provided.

### CROSS REFERENCE TO RELATED APPLICATION

This application claims the benefit of U.S. Provisional Application No. 60/613,696, filed Sep. 28, 2004.

### FIELD OF THE INVENTION

The present invention relates to a process for preparing an aqueous automatic dishwashing (ADW) detergent composition having good dispensability and product clarity. More particularly, the present invention relates to a process for preparing substantially sodium ion-free, aqueous ADW detergent compositions comprising potassium tripolyphosphate formed by in-situ hydrolysis.

### BACKGROUND OF THE INVENTION

It is known that soluble, reversion-stable phosphate builders (such as, sodium tripolyphosphate, potassium tripolyphosphate, and mixed sodium potassium tripolyphosphate, etc.) can be used to prepare automatic dishwashing detergent formulations for use in ADW appliances. Sodium tripolyphosphate builders may be commercially prepared by hydrolysis of sodium trimetaphosphate with a strong base (such as, sodium hydroxide, potassium hydroxide, ammonium hydroxide, etc). However, sodium hydroxide and ammonium hydroxide bases generally provide undesirable results. In particular, if sodium hydroxide is used in the hydrolysis of sodium trimetaphosphate, the resulting sodium tripolyphosphate formed has only limited solubility. Moreover, hydrolysis of sodium trimetaphosphate with ammonium hydroxide will liberate ammonia in the presence of an alkalinity source.

Alternatively, a stable, free-flowing, homogeneous aqueous detergent composition can be commercially prepared by hydrolysis of sodium trimetaphosphate with potassium hydroxide base. While sodium trimetaphosphate itself is not a sequestering agent, its reaction with the potassium hydroxide converts the trimetaphosphate anion to the tripolyphosphate anion to form both a sodium tripolyphosphate and a mixed sodium potassium tripolyphosphate. However, due to the limited solubility of the sodium-containing phosphate builders, as stated above, these ADW detergent formulations are undesirable due to the presence of large amounts of suspended solids, which tend to increase cloudiness, reduce dispensability (e.g. excessive viscosity), and sometimes, in sufficient quantities, tend to promote lumpiness in aqueous ADW detergent compositions.

While commercial potassium tripolyphosphate builders are sufficiently soluble, the cost of potassium tripolyphosphate does not make it economically feasible to provide a reasonably priced, consumer-based detergent product. Commercial preparations of potassium tripolyphosphate are expensive. While commercial spray-drying operations produce solid, light density, potassium tripolyphosphate particles, spray drying can further add to manufacturing costs. Although, other commercial manufacturing processes are available that do not require spray drying, these processes are directed only to preparing potassium tripolyphosphate in the form of particulate solids having varying bulk densities. Furthermore, the use of potassium orthophosphate and pyrophosphate builders in aqueous ADW detergent compositions are not nearly as effective in “building” detergent products as is potassium tripolyphosphate. Therefore, since the use of commercially-supplied potassium tripolyphosphate for the preparation of aqueous ADW detergent compositions is uneconomical for consumer product manufacturers, as compared with the more commercially viable sodium tripolyphosphate, there remains a need for a process that can produce potassium tripolyphosphate economically so that it may be used to prepare competitively-priced, aqueous ADW detergent compositions and products.

### SUMMARY OF THE INVENTION

The present invention relates to a process for preparing substantially sodium ion-free, aqueous ADW detergent compositions comprising potassium tripolyphosphate formed by in-situ hydrolysis. A process for preparing a substantially sodium ion-free, aqueous ADW detergent composition comprising potassium tripolyphosphate formed by in-situ hydrolysis is provided. The process comprises the steps of: (a) reacting potassium trimetaphosphate with potassium hydroxide to form a reaction mixture comprising potassium tripolyphosphate according to the following formula: (KPO₃)₃+2 KOH→K₅P₃O₁₀+H₂O; and (b) adding at least one adjunct ingredient to form said composition; wherein said potassium tripolyphosphate is formed by in-situ hydrolysis; wherein said composition is substantially free of sodium ions; and wherein said composition is aqueous.

### DETAILED DESCRIPTION OF PREFERRED EMBODIMENTS

Substantially sodium ion-free, aqueous ADW detergent compositions having good dispensability and product clarity may be prepared without using commercially-prepared, granular potassium tripolyphosphate (KTPP) materials. It has surprisingly been found that when potassium trimetaphosphate is hydrolyzed under in-situ hydrolysis in the presence of potassium hydroxide, an inexpensive, substantially sodium ion-free, highly soluble potassium tripolyphosphate may be formed in a slurry mixture according to the following formula:
(KPO₃)₃+2KOH→K₅P₃O₁₀+H₂O,
which can readily be used as detergent base or provided in part as a premix for preparing an aqueous ADW detergent composition at less cost than adding commercially-prepared, granular potassium tripolyphosphate directly.

The term “KTMP” refers to potassium trimetaphosphate or (KPO₃)₃. The term “KTPP” refers to potassium tripolyphosphate or K₅P₃O₁₀.

In general, when KTPP is formed in-situ, the reaction is carried out by slurry mixing KTMP with water in a jacketed tank or mixing vessel. Potassium hydroxide (“KOH”) is added in solid or aqueous form. If the aqueous form is used, the KOH may be initially heated to about 45° C. The rate of addition of the KOH may be controlled so that the temperature in the mixing vessel is maintained between about 45° and about 120° C. Alternatively, the temperature may be maintained between about 45° and about 115° C., between about 45° and about 110° C., between about 45° and about 105° C., between about 45° and about 100° C., between about 45° and about 90° C., between about 50° and about 80° C., or between about 60° and about 80° C. Once the KTMP and KOH are slurried into the mixing vessel, and the reaction completed, the adjunct ingredients are then added and mixed in any order desired. The resulting, substantially sodium ion-free, aqueous ADW detergent composition is then placed in an appropriate container or package (e.g. bottle, bag, dispenser, water-soluble pouch, gel pack, etc.) for eventual distribution and sale to the consumer.

Control of the rate of hydration of the KTPP salt, when formed within the detergent slurry process, may be desirable. Generally, the higher the temperature of the aqueous mixture of KOH and KTMP, the faster is the rate of formation of the KTPP that results from the alkaline conversion of KTMP described in the formula above. The rate of conversion of KTMP to KTPP can be increased by increasing the ionic strength (concentration) of given detergent slurry. Thus, very high rates of conversion in the processes can advantageously be achieved by utilizing concentrated detergent slurries. The presence of at least about 0.5%, by weight of the slurry mixture of potassium sulfate, when added to the slurry during conversion of the potassium trimetaphosphate to potassium triphosphate, in some way may act as a catalyst for the in-situ hydrolysis reaction to increase the tripolyphosphate conversion rate.

The amount of KOH utilized in the in-situ process will be an amount sufficient to furnish enough hydroxyl ions to the reaction so that at least a substantial amount or proportion (e.g., at least about 50%, at least about 55%, at least about 60%, at least about 65%, at least about 70%, at least about 75%, at least about 80%, at least about 85%, at least about 90%, at least about 95%, at least about 99%, and alternatively 100%) of the KTMP in the slurry can be converted into the corresponding KTPP.

Because two moles of hydroxyl ions are necessary to substantially convert one mole of KTMP to KTPP, the amount of the KOH that can be utilized (in the slurry) will generally be at least enough to furnish at least about one, at least about 1.1, at least about 1.2, at least about 1.3, at least about 1.4, at least about 1.5, at least about 1.6, at least about 1.7, at least about 1.8, at least about 1.9, at least about 2.0, and alternatively, at least about 2.1 mole equivalents of hydroxyl ions per mole of KTMP, which is present in the slurry. When substantially complete conversion of the KTMP is desired, the slurry mixture should be formulated to contain at least about two moles of KOH per mole KTMP therein.

Any suitable amount of KTMP may be used herein to prepare any suitable amount of KTPP. In certain non-limiting embodiments, a suitable amount of KTMP that is converted during in-situ hydrolysis is that amount which provides from about 20% to about 50%, from about 20% to about 40%, and alternatively from about 25% to about 35% of potassium tripolyphosphate, by weight of the composition, after in-situ hydrolysis is substantially completed (e.g. 100% of the KTMP in the slurry is converted to KTPP). As stated above, the process described herein may provide any suitable amount of KTPP. Suitable amounts of KTPP prepared by in-situ hydrolysis include, but are not limited to: an amount from about 20% to about 50%, from about 20% to about 40%, and alternatively, from about 25% to about 35%, by weight of the composition.

Detergent slurries are well-known in the art, and need not be detailed here, except to point out that those which can be used in the processes described herein contain enough water to keep the potassium tripolyphosphate hydrated once it is formed. The amount of water required to hydrate KTPP is calculated by the following chemical equation:
KTPP+6H2O→KTPP*6H2O,
wherein the “KTPP*6H2O” represents potassium tripolyphosphate hexahydrate. For example, if the slurry mixture contains 20% by weight, KTPP, the total amount of water needed to substantially convert the KTPP to KTPP*6H2O is at least about 5.87%, by weight of the slurry. In certain non-limiting embodiments, detergent slurries contain at least about 5.87% water, at least about 10% water, at least about 15% water, at least about 20% water, at least about 30% water, at least about 35% water, at least about 45% water, at least about 50% water, at least about 55% water, at least about 60% water, at least about 65% water, at least about 70% water, at least about 75% water, at least about 80% water, at least about 85% water, at least about 90% water, at least about 95% water, and alternatively at least about 99% water, based on the total weight of the completely formulated slurry mixture.

Any suitable amount of the slurry mixture may be used (such as, a detergent base or as a premix) in the process to prepare the substantially sodium ion-free, aqueous ADW detergent composition. In one non-limiting embodiment, the slurry mixture may be used at 100% concentration and in combination with at least one adjunct ingredient to form the resulting, aqueous ADW detergent composition. However, any suitable dilution may be used herein. Suitable diluents may include, but are not limited to: carrier mediums and/or solvents.

Any suitable amount of water may be used in the process to prepare the substantially sodium ion-free, aqueous ADW detergent composition (hereinafter “resulting, aqueous ADW detergent composition”). Suitable amounts of water may include, but are not limited to a range of from about 5.87% to about 80% water, by weight of the composition. Alternatively, the resulting, aqueous ADW detergent composition may comprise from about 10% to about 70% water, from about 15% to about 60% water, from about 20% to about 50% water, from about 25% to about 50% water, from about 30% to about 50% water, and from about 35% to about 50% water, by weight of the composition.

Sodium ions may unintentionally be present as a raw material impurity and/or a contaminant. The expression “substantially free of sodium ions” means that the resulting, aqueous ADW detergent composition may have less than about 1% sodium ions present, by weight of the composition. In certain embodiments, the resulting, aqueous ADW detergent composition may comprise sodium ions in an amount less than about 0.1%, and alternatively, less than about 0.01%, by weight of the composition.

pH

Any suitable pH may be used during any step or combination of steps utilized in the process described herein so long as the pH of the resulting, aqueous ADW detergent composition falls within the range of from about 7 to about 12, as measured by a 1% aqueous solution. For example, certain non-limiting embodiments of the resulting, aqueous ADW detergent composition have a pH of greater than or equal to about 7, or greater than or equal to about 9, or greater than or equal to about 10, greater than or equal to about 11, and alternatively, about 12, as measured by a 1% aqueous solution.

Viscosity and Yield Value

This process herein may be used to prepare a substantially sodium ion-free, aqueous ADW detergent composition that is to be dispensed from a container (e.g. bottle, multi-compartmental bottle, etc.). The viscosity may be in the range of from about 100 CPS to about 1,000,000 CPS, as measured herein with a Contravis Rheomat 115 viscometer utilizing a Rheoscan 100 controller and a DIN145 spindle at 25° C. Alternatively, the viscosity range may be from about 500 CPS to about 500,000 CPS, from about 1,000 CPS to about 100,000 CPS, from about 1,000 CPS to about 50,000 CPS, and from about 10,000 CPS to about 28,000 CPS. The yield value of the resulting, aqueous ADW detergent composition may be in the range of from about 20 to about 500, from about 50 to about 350, and alternatively from about 100 to about 250. The yield value is an indication of the shear stress at which the gel strength is exceeded and flow is initiated. It is measured herein with a Contravis Rheomat 115 viscometer utilizing a Rheoscan 100 controller and a DIN145 spindle at 25° C. The shear rate may rise linearly from 0 to about 0.4 inverse second over a period of 10 minutes after an initial 5-minute rest period.

The process herein may also be used to prepare a substantially sodium ion-free, aqueous ADW detergent composition that is to be dispensed in the form of a unitized dose (e.g. gel pack, water-soluble pouch, multi-compartmental water-soluble pouch, and combinations thereof). The viscosity range at 1 inverse second of a unitized dose of the resulting, aqueous ADW detergent composition may be from about 100 CPS to about 1,000,000 CPS, from about 500 CPS to about 500,000 CPS, from about 1,000 CPS to about 100,000 CPS, from about 1,000 CPS to about 50,000 CPS, and alternatively, from about 1,000 CPS to about 20,000 CPS as measured herein with a Contravis Rheomat 115 viscometer utilizing a Rheoscan 100 controller and a DIN145 spindle at 25° C.

Adjunct Ingredients

Any suitable adjunct ingredient may be added during the process in any form or amount to prepare the resulting, aqueous ADW detergent composition. Suitable adjunct ingredients as described herein are substantially sodium ion-free. Suitable adjunct ingredients include, but are not limited to: surfactants, such as, anionic surfactants, cationic surfactants, nonionic surfactants (e.g. TETRONIC® by the BASF-Wyandotte Corp., Wyandotte, Mich.; and Olin Corporation's POLY-TERGENTS® SLF-18), amphoteric surfactants, ampholytic surfactants, and zwitterionic surfactants; suds suppressors, such as low foaming, non-ionic surfactants with cloud points less than about 35° C.; co-builders, such as orthophosphates, pyrophosphates, tripolyphosphates, carbonates, bicarbonates, hydroxides, silicates, water insoluble aluminosilicates, citrates (e.g. potassium citrate monohydrate), nitrilotriacetates, ethylenediamintetraacetates, oxydisuccinates, mellitates, and metal ion sequestrants; bleaching agents, such as, halogenated bleach (e.g. potassium hypochlorite) and oxygen bleach, including peroxide bleach, percarbonate bleach, and perborate bleach; encapsulated bleach agents (e.g. encapsulated potassium hypochlorite); bleach activators; bleach catalysts; enzymes, such as proteases, amylases, lipases, cellulases, and peroxidases; thickening agents, such as cross-linked polycarboxylate polymers with a weight-average molecular weight of at least about 500,000 (e.g. CARBOPOL® 980 from B.F. Goodrich), naturally occurring or synthetic clays, starches, celluloses, alginates, and natural gums (e.g. xanthum gum); enzyme stabilizing agents, such as, propylene glycol and glycerine; potassium counter ions, such as, potassium salts including potassium chloride; chelating agents, such as, alkali metal ethane 1-hydroxy diphosphonates (HEDP), alkylene poly (alkylene phosphonate), as well as, amino phosphonate compounds, including amino aminotri(methylene phosphonic acid) (ATMP), nitrilo trimethylene phosphonates (NTP), ethylene diamine tetra methylene phosphonates, and diethylene triamine penta methylene phosphonates (DTPMP); alkalinity sources; pH buffering agents, such as, amino acids, tris(hydroxymethyl)amino methane (TRIS), 2-amino-2-ethyl-1,3-propanediol, 2-amino-2-methyl-propanol, 2-amino-2-methyl-1,3-propanol, potassium glutamate, N-methyl diethanolamide, 1,3-diamino-propanol N,N′-tetra-methyl-1,3-diamino-2-propanol, N,N-bis(2-hydroxyethyl)glycine (bicine), N-tris (hydroxymethyl)methyl glycine (tricine), potassium carbonate, potassium polyphosphate, and organic diamines; water softening agents; secondary solubility modifiers; soil release polymers; dispersant polymers, such as, acrylic acid, maleic acid (or maleic anhydride), fumaric acid, itaconic acid, aconitic acid, mesaconic acid, citraconic acid, methylenemalonic acid, polyaspartate, and carboxylated polysaccharides; hydrotropes; binders; carrier mediums, such as tap water, distilled water, deionized water; solvents, such as, ethers and diethers having from 4 to 14 carbon atoms, from 6 to 12 carbon atoms (alternatively, from 8 to 10 carbon atoms), glycols or alkoxylated glycols, glycol ethers, alkoxylated aromatic alcohols, aromatic alcohols, and simple alcohols; antibacterial actives, such as citric acid, benzoic acid, benzophenone, thymol, eugenol, menthol, geraniol, vertenone, eucalyptol, pinocarvone, cedrol, anethol, carvacrol, hinokitiol, berberine, ferulic acid, cinnamic acid, methyl salicylic acid, methyl salicylate, terpineol, limonene, and halide-containing compounds; detergent fillers (e.g. potassium sulfate); abrasives, such as, quartz, pumice, pumicite, titanium dioxide, silica sand, calcium carbonate, zirconium silicate, diatomaceous earth, whiting, and feldspar; anti-redeposition agents, such as organic phosphate; anti-oxidants; anti-tarnish agents, such as benzotriazole; anti-corrosion agents, such as, aluminum-, magnesium-, zinc-containing materials (e.g. hydrozincite and zinc oxide); processing aids; plasticizers (e.g. propylene glycol and glycerine); aesthetic enhancing agents, such as dyes, colorants, pigments, speckles, perfume, and oils; preservatives; and mixtures thereof. Suitable adjunct ingredients may contain low levels of sodium ions by way of impurities or contamination. In certain non-limiting embodiments, adjunct ingredients may be added during any step in the process in an amount from about 0.0001% to about 99%, by weight of the composition.

Adjunct ingredients suitable for use are disclosed, for example, in U.S. Pat. Nos.: 3,128,287; 3,159,581; 3,213,030; 3,308,067; 3,400,148; 3,422,021; 3,422,137; 3,629,121; 3,635,830; 3,835,163; 3,923,679;3,929,678; 3,985,669; 4,101,457; 4,102,903; 4,120,874; 4,141,841; 4,144,226; 4,158,635; 4,223,163; 4,228,042; 4,239,660; 4,246,612; 4,259,217; 4,260,529; 4,530,766; 4,566,984; 4,605,509; 4,663,071; 4,663,071; 4,810,410; 5,084,535; 5,114,611; 5,227,084; 5,559,089; 5,691,292; 5,698,046; 5,705,464; 5,798,326; 5,804,542; 5,962,386; 5,967,157; 5,972,040; 6,020,294; 6,113,655; 6,119,705; 6,143,707; 6,326,341; 6,326,341; 6,593,287; and 6,602,837; European Patent Nos.: 0,066,915; 0,200,263; 0332294; 0414 549; 0482807; and 0705324; PCT Pub. Nos.: WO 93/08876; and WO 93/08874; German Patent application No. 2,321,001; and Great Britain Pat. Appl. Nos.: A-836988; A-855735; A-864798; A-1147871; A-1586789; A-2143231; and A-1246338. See also Kirk Othmer's Encyclopedia of Chemical Technology, 3rd Ed., Vol. 22, pp. 360-379, “Surfactants and Detersive Systems” and Vol. 17, pp. 426-472 and in “Advanced Inorganic Chemistry” by Cotton and Wilkinson, pp. 394400 (John Wiley and Sons, Inc.; 1972).

### EXAMPLES

The following examples of processes for preparing substantially sodium ion-free, aqueous ADW detergent compositions are provided for purposes of showing certain embodiments, and as such, are not intended to be limiting in any manner. Amounts are expressed in units of percent weight of the resulting, aqueous ADW detergent composition.

### Example 1

A slurry mixture is prepared in a separate jacket-lined mixing vessel by dispersing 20% wt. KTMP in 53.34% wt. water for about ten minutes at 100 rpm to 300 rpm mixing speed to form a slurry. Subsequently, 14.06% wt. of a 45% active KOH is added and reacted with the KTMP in-situ to form KTPP by hydrolysis. Optionally, the 45% active KOH is initially heated to about 45° C. prior to addition. Optionally, 0.5% wt. potassium sulfate is added to the mixture. Slurry mixing is continued for about ten minutes until the solids are dissolved. Then, 7.0% wt. granular potassium silicate is added next to the main mixture and mixed for ten minutes at 300 rpm to 600 rpm mixing speed. Optionally, heat is applied by passing hot water or steam through the jacket during mixing, if required, to dissolve the silicate solids. Then, 1.2% wt. encapsulated potassium hypochlorite is dry blended in a separate vessel along with the 1% wt. nonionic surfactant (TETRONIC®) and the 2% wt. dye, pigments, speckles, and/or colorants to form a dry blend. This dry blend is then added to the mixing vessel to achieve a homogeneous dispersion in about two minutes of agitation at 100 rpm to 300 rpm mixing speed. Then, 0.5% wt. xanthum gum is then added to the mixing vessel to achieve viscosity of about 22,000 cps in the finished product in about ten minutes at 300 rpm to 600 rpm mixing speed. The mixture is optionally cooled using a cold-water jacket. Then, 0.9% wt. perfume is added and dispersed in about 2 minutes at 100 rpm to 300 rpm mixing speed to form the resulting, aqueous ADW detergent composition, which is then placed in a bottle. Mixing times add up to about 44 minutes.

### Example 2

A slurry mixture is prepared in a separate jacket-lined, main mixing vessel by dispersing 33.19% wt. KTMP in 27.55% by weight, water for about ten minutes at 100 rpm to 300 rpm mixing speed to form a slurry. Subsequently, 23.35% wt. of a 45% active solution of KOH is added and reacted with the KTMP in-situ to form KTPP by hydrolysis. Optionally, the 45% active KOH is initially heated to about 45° C. prior to addition. Optionally, 0.5% wt. potassium sulfate is added to the mixture. Slurry mixing is continued for about ten minutes until the solids are dissolved. Then, 12.70% wt. granular potassium citrate monohydrate is added to the slurry mixture and mixed for ten minutes at 300 rpm to 600 rpm mixing speed. Optionally, additional heat is applied by passing hot water or steam through the jacket during mixing, if required, to dissolve the citrate solids.

In a separate mixing vessel, 1% wt. of TETRONIC® nonionic surfactant and 0.2% wt. dye, pigments, speckles, and/or colorants to form a dry blend. This dry blend is then added to the main mixing vessel to achieve a homogeneous dispersion in about two minutes of agitation at 100 rpm to 300 rpm mixing speed.

Then, 0.6% wt. CARBOPOL® 980 polymeric thickener is added to the main mixing vessel to achieve viscosity of about 2,000 cps @ 1 inverse second in the mixture in about fifteen minutes at 300 rpm to 600 rpm mixing speed. The mixture is optionally cooled using a cold-water jacket. Then, 0.16% wt. perfume is added and dispersed in about 2 minutes at 100 rpm to 300 rpm mixing speed. Finally, 1.0% wt. of a protease enzyme and 0.2% wt. of an amylase enzyme are added to the mixture and dispersed in about 2 minutes at 100 rpm to 300 rpm mixing speed to form the resulting, aqueous ADW detergent composition, which is then placed in a water-soluble pouch. Optionally, and prior to receiving the resulting, aqueous ADW detergent composition, the water-soluble pouch may be coated or partially coated with glycerine on its interior surface. Mixing times add up to about 51 minutes.

With reference to the polymers described herein, the term weight-average molecular weight is the weight-average molecular weight as determined using gel permeation chromatography according to the protocol found in Colloids and Surfaces, Physico Chemical & Engineering Aspects, Vol. 162, 2000, pg. 107-121. The units are Daltons.

The disclosure of all patents, patent applications (and any patents which issue thereon, as well as any corresponding published foreign patent applications), and publications mentioned throughout this description are hereby incorporated by reference herein. It is expressly not admitted, however, that any of the documents incorporated by reference herein teach or disclose the present invention.

It should be understood that every maximum numerical limitation given throughout this specification would include every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A process for preparing an automatic dishwashing detergent composition comprising the following steps:
(a) reacting potassium trimetaphosphate with potassium hydroxide to form a reaction mixture comprising potassium tripolyphosphate according to the following formula:
(KPO₃)₃+2KOH→K₅P₃O₁₀+H₂O; and
(b) adding at least one adjunct ingredient to form said composition; wherein said potassium tripolyphosphate is formed by in-situ hydrolysis; wherein said composition is substantially free of sodium ions; and wherein said composition is aqueous.

2. A process according to claim 1 wherein said suitable amount of said potassium trimetaphosphate converted during said in-situ hydrolysis that provides from about 20% to about 50% of said potassium tripolyphosphate, by weight of the composition, after said in-situ hydrolysis is substantially completed.

3. A process according to claim 2 wherein said suitable amount of said potassium trimetaphosphate, converted during said in-situ hydrolysis, that provides from about 20% to about 40% of potassium tripolyphosphate, by weight of the composition, after said in-situ hydrolysis is substantially completed.

4. A process according to claim 3 wherein said suitable amount is the amount of said potassium trimetaphosphate, converted during said in-situ hydrolysis, that provides from about 25% to about 35% of potassium tripolyphosphate, by weight of the composition, after said in-situ hydrolysis is substantially completed.

5. The process according to claim 1 further comprising the step of adding to said mixture about 0.5%, by weight of the composition, of potassium sulfate.

6. The process according to claim 1, wherein said mixture is maintained at a temperature below about 105° C.

7. The process according to claim 6, wherein said mixture is maintained below about 100° C.

8. The process according to claim 1, wherein said composition has a viscosity in the range of from about 100 to about 1,000,000 cps as measured by Contravis Rheomat 115 viscometer.

9. The process according to claim 8, wherein said viscosity range is from about 500 to about 50,000 cps.

10. The process according to claim 9, wherein said viscosity range is from about 1,000 to about 28,000 cps.

11. The process according to claim 1, wherein said adjunct ingredient is selected from the group consisting of: potassium counter ions, surfactants, suds suppressors, co-builders, sequestrants, bleaching agents, bleach activators, bleach catalysts, enzymes, thickening agents, enzyme stabilizing agents, chelating agents, alkalinity sources, pH buffering agents, water softening agents, secondary solubility modifiers, soil release polymers, dispersant polymers, hydrotropes, fillers, binders, carrier mediums, oils, organic solvents, antibacterial actives, abrasives, anti-redeposition agents, anti-tarnish agents, anti-corrosion agents, aesthetic enhancing agents, processing aids, plasticizers, preservatives, and mixtures thereof.

12. The process according to claim 11, wherein said surfactant is selected from the group consisting of anionic surfactants, cationic surfactants, nonionic surfactants, amphoteric surfactants, ampholytic surfactants, zwitterionic surfactants, and mixtures thereof.

13. The process according to claim 12, wherein said surfactant is a non-ionic surfactant.

14. The process according to claim 11, wherein said enzyme is selected from the group consisting of proteases, amylases, lipases, cellulases, peroxidases, and mixtures thereof.

15. The process according to claim 11, wherein said bleaching agent is selected from the group consisting of halogenated bleach, oxygen bleach, and mixtures thereof.

16. The process according to claim 15, wherein said bleaching agent is encapsulated.

17. The process according to claim 16, wherein said bleaching agent is potassium hypochlorite.

18. The process according to claim 1, wherein said composition comprises from about 5.87% to about 80% water, by weight of the composition.

19. The process according to claim 1, wherein the pH of said composition falls within the range of from about 7 to about 12, as measured by a 1% aqueous solution.

20. The process according to claim 1, wherein said composition is prepared in one or more of the following forms: a liquid, a liquigel, a gel, a foam, a cream, and a paste.
